(19) United States
(12) Patent Application Publication
(10) Pub. No.: US 2022/0080442 A1
(43) Pub. Date: Mar. 17, 2022

(54) Corner Spray Shield Apparatus

(71) Applicant: Daynel Dominguez Diaz, Lawrenceville, GA (US)

(72) Inventor: Daynel Dominguez Diaz, Lawrenceville, GA (US)

(21) Appl. No.: 17/022,238

(22) Filed: Sep. 16, 2020

(51) Int. Cl. B05B 12/22

(52) U.S. Cl. CPC B05B 12/22

(57) ABSTRACT

A corner spray shield apparatus for easily spraying inside and outside corners while painting includes a handle having a handle proximal end and a handle distal end. An arm is coupled to the handle. The arm is coupled to the handle distal end. A shield is pivotably coupled to the arm. The shield lies parallel and adjacent to the arm extension portion. The shield is V-shaped and has an outer shield edge forming a right angle and an inner shield edge forming a right angle. The outer shield edge engages an inside corner between two walls and the inner shield edge engages an outside corner between two walls. A pivot rod is coupled to the shield. The pivot rod is fixedly coupled to the shield and pivotably coupled to a pivot aperture extending through an arm extension portion of the arm.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to spray shield devices and more particularly pertains to a new spray shield device for easily spraying inside and outside corners while painting.

### (2) Description of Related Art Including Information Disclosed Under 37 CFR 1.97 and 1.98

The prior art relates to spray shield devices. Known spray shield devices typically do not accommodate corners. Those that do may have multiple moving components and often lack a handle. Such devices do not accommodate both outside and inside corners by selectively pivoting on the handle.

### BRIEF SUMMARY OF THE INVENTION

An embodiment of the disclosure meets the needs presented above by generally comprising a handle having a handle proximal end and a handle distal end. An arm is coupled to the handle. The arm is coupled to the handle distal end. A shield is pivotably coupled to the arm. The shield lies parallel and adjacent to an arm extension portion of the arm. The shield is V-shaped and has an outer shield edge forming a right angle and an inner shield edge forming a right angle. The outer shield edge is configured to engage an inside corner between two walls and the inner shield edge is configured to engage an outside corner between two walls. A pivot rod is coupled to the shield. The pivot rod is fixedly coupled to the shield and pivotably coupled to a pivot aperture extending through the arm extension portion.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a corner spray shield apparatus according to an embodiment of the disclosure.

FIG. 2 is an isometric view of an embodiment of the disclosure.

FIG. 3 is an isometric view of an embodiment of the disclosure.

FIG. 4 is a cross-sectional view of an embodiment of the disclosure along the line 4-4 of FIG. 2.

FIG. 5 is a bottom plan view of an embodiment of the disclosure.

### DETAILED DESCRIPTION OF THE INVENTION

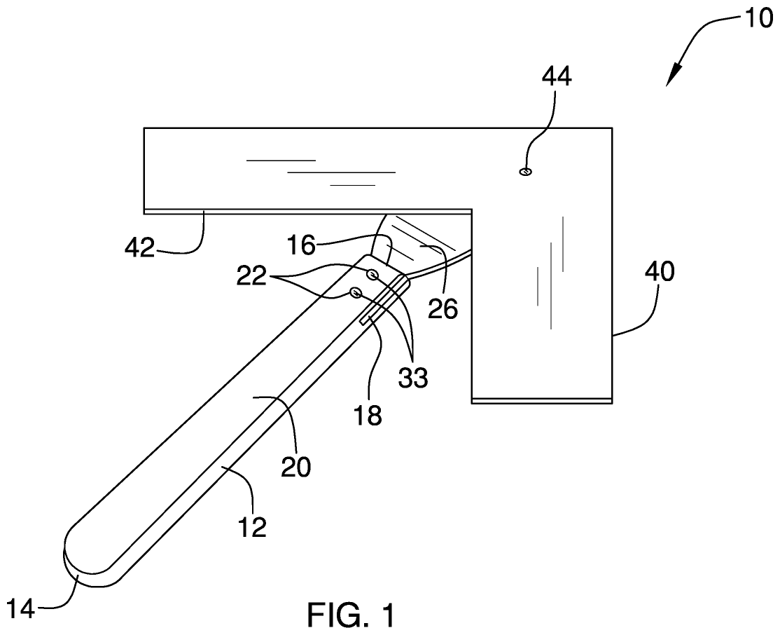

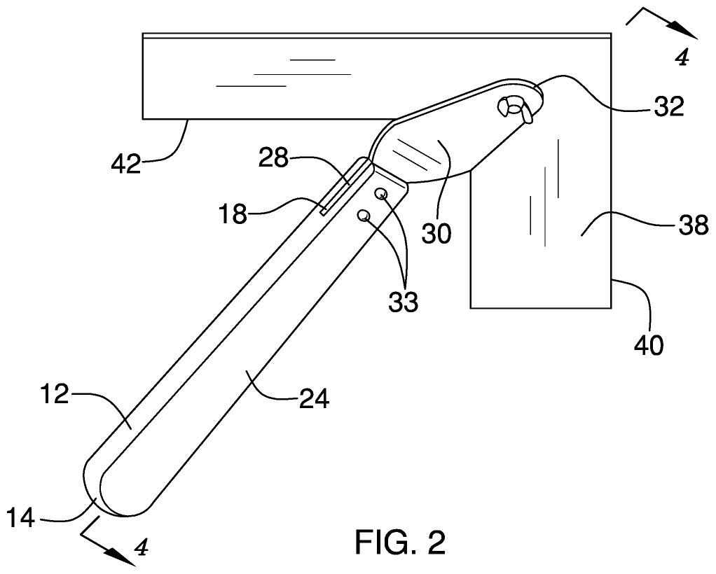

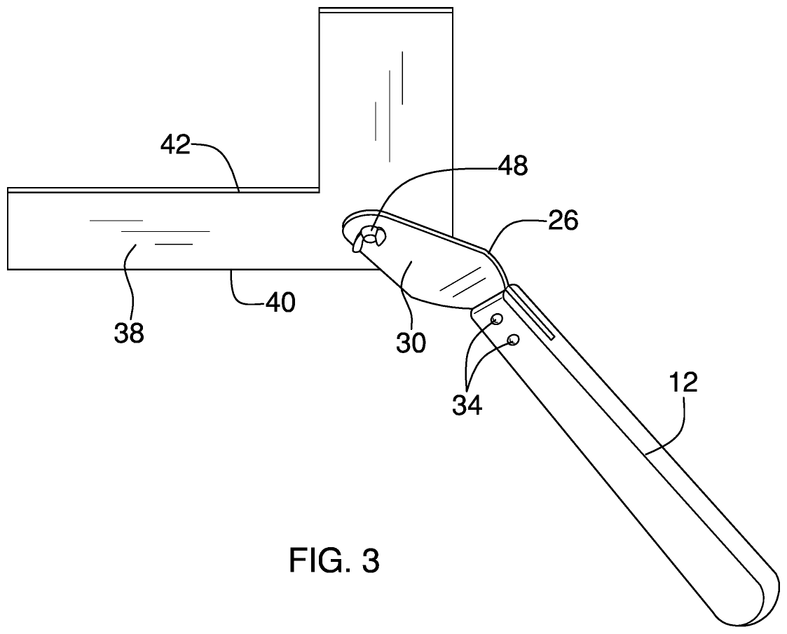

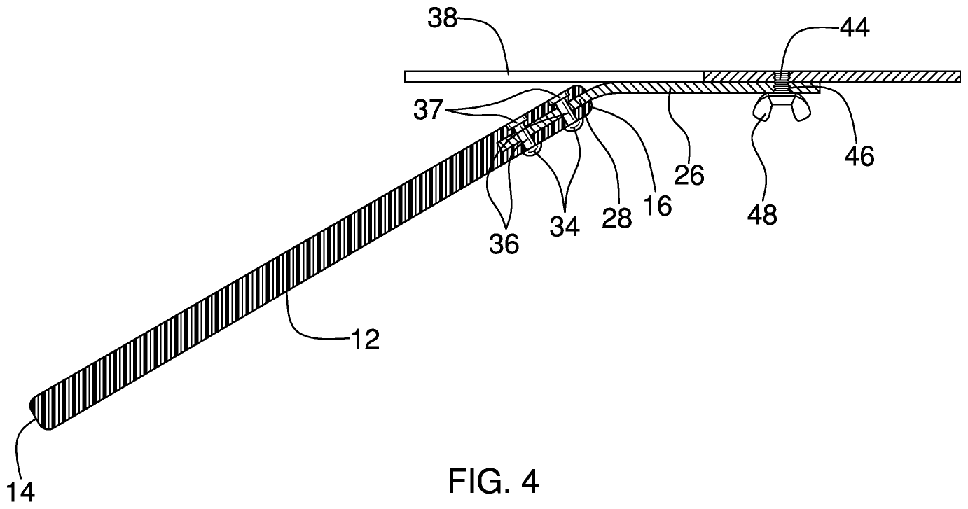

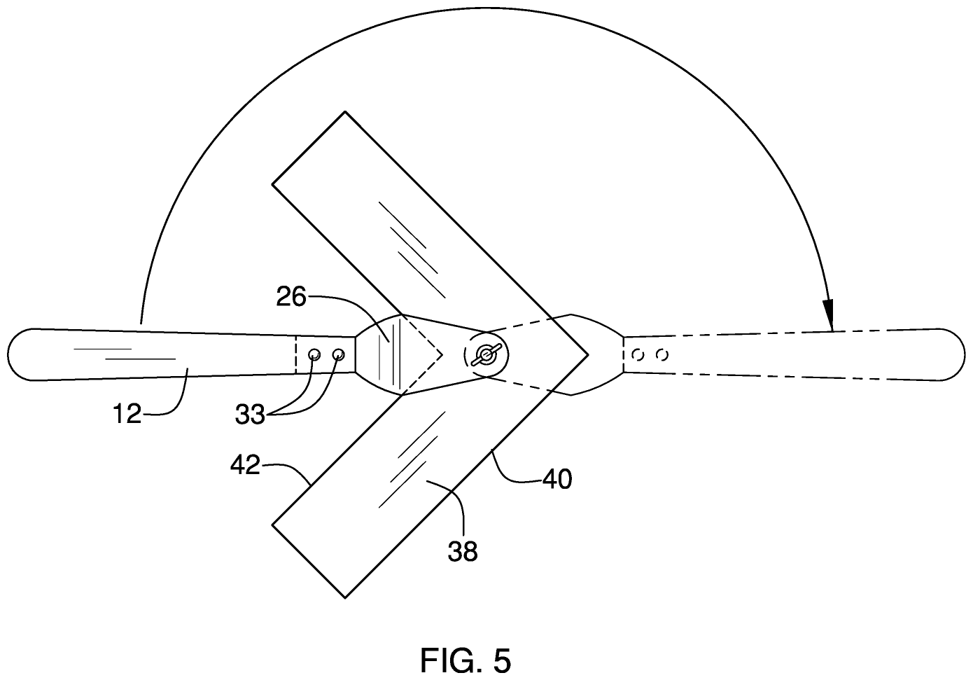

With reference now to the drawings, and in particular to FIGS. 1 through 5 thereof, a new spray shield device embodying the principles and concepts of an embodiment of the disclosure and generally designated by the reference numeral 10 will be described.

As best illustrated in FIGS. 1 through 5, the corner spray shield apparatus 10 generally comprises a handle 12 having a handle proximal end 14 and a handle distal end 16. The handle proximal end 14 may be rounded and the handle distal end 16 may be squared. The handle distal end 16 may have a receiving slot 18. A handle top side 20 of the handle may have a pair of engagement apertures 22 extending through the receiving slot 18 and a handle bottom side 24 of the handle.

An arm 26 is coupled to the handle 12. The arm 26 is coupled to the handle distal end 16 with an arm engagement portion 28 positioned within the receiving slot 18. The engagement portion of the arm 28 may conform to the receiving slot 18. The arm 26 has an arm extension portion 30 lying in a plane forming an angle between 110° and 170° with a plane of the handle 12. The arm extension portion 30 may taper towards a rounded arm distal end 32.

A pair of pins 33 is coupled to the handle 12 and the arm 26. The pair of pins 33 extends through the engagement apertures 22 and the engagement portion 28 of the arm. Each of the pair of pins 33 may have a rounded head portion 34 protruding below the handle bottom side 24, a shaft portion 36 within the respective engagement aperture 22, and a flat pin top portion 37 with the handle top side 20.

A shield 38 is pivotably coupled to the arm 12. The shield 38 lies parallel and adjacent to the arm extension portion 30. The shield 38 is V-shaped and has an outer shield edge 40 forming a right angle and an inner shield edge 42 forming a right angle. The outer shield edge 40 is configured to engage an inside corner between two walls and the inner shield edge 42 is configured to engage an outside corner between two walls.

A pivot rod 44 is coupled to the shield 38. The pivot rod 44 is fixedly coupled to the shield 38 and extends through a pivot aperture 46 of the arm extension portion proximal the arm distal end 32. The pivot rod 44 is positioned along the axis of symmetry of the shield 38. The pivot rod 44 may be threaded. A wing nut 48 may be coupled to the pivot rod 44. The wing nut 48 selectively locks the shield 38 in place or allows the shield 38 to pivot relative the arm 26 to move between use for inside corners and outside corners.

In use, the handle 12 is secured and the shield 38 is positioned as needed for an inside corner or an outside corner. The wing nut 48 is tightened to prevent unwanted movement and the shield 38 is positioned where needed during spraying to prevent overspray.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A corner spray shield apparatus comprising:
a handle, the handle having a handle proximal end and a handle distal end;
an arm coupled to the handle, the arm being coupled to the handle distal end, the arm having an arm extension portion, the arm extension portion being planar;
a shield pivotably coupled to the arm, the shield being planar lying parallel and adjacent to the arm extension portion of the arm, the shield being V-shaped and having an outer shield edge forming a right angle and an inner shield edge forming a right angle, the outer shield edge being coplanar with the inner shield edge, the outer shield edge being configured to engage an inside corner between two walls and the inner shield edge being configured to engage an outside corner between two walls; and
a pivot rod coupled to the shield, the pivot rod being fixedly coupled to the shield and pivotably coupled to a pivot aperture extending through the arm extension portion.

2. The corner spray shield apparatus of claim 1 further comprising the arm extension portion lying in a plane forming an angle between 110° and 170° with a plane of the handle, the pivot rod being coupled proximal an arm distal end of the arm extension portion.

3. The corner spray shield apparatus of claim 2 further comprising the arm distal end being rounded.

4. The corner spray shield apparatus of claim 3 further comprising the arm extension portion tapering towards the arm distal end.

5. The corner spray shield apparatus of claim 1 further comprising the pivot rod being threaded; a wing nut coupled to the pivot rod, the wing nut selectively locking the shield in place or allowing the shield to pivot relative the arm.

6. The corner spray shield apparatus of claim 1 further comprising the handle distal end having a receiving slot, a handle top side of the handle having a pair of engagement apertures extending through the receiving slot and a handle bottom side; a pair of pins extending through the engagement apertures and an engagement portion of the arm.

7. The corner spray shield apparatus of claim 6 further comprising the engagement portion of the arm conforming to the receiving slot.

8. A corner spray shield apparatus comprising:
a handle, the handle having a handle proximal end and a handle distal end, the handle distal end having a receiving slot, a handle top side of the handle having a pair of engagement apertures extending through the receiving slot and a handle bottom side;
an arm coupled to the handle, the arm being coupled to the handle distal end, the arm having an arm extension portion, the arm extension portion being planar lying in a plane forming an angle between 110° and 170° with a plane of the handle, the arm extension portion tapering towards a rounded arm distal end;
a pair of pins coupled to the handle and the arm, the pair of pins extending through the engagement apertures and an engagement portion of the arm, the engagement portion of the arm conforming to the receiving slot;
a shield pivotably coupled to the arm, the shield being planar, the shield lying parallel and adjacent to the arm extension portion, the shield being V-shaped and having an outer shield edge forming a right angle and an inner shield edge forming a right angle, the outer shield edge being coplanar with the inner shield edge, the outer shield edge being configured to engage an inside corner between two walls and the inner shield edge being configured to engage an outside corner between two walls;
a pivot rod coupled to the shield, the pivot rod being fixedly coupled to the shield and extending through a pivot aperture of the arm extension portion proximal the arm distal end, the pivot rod being threaded; and
a wing nut coupled to the pivot rod, the wing nut selectively locking the shield in place or allowing the shield to pivot relative the arm to move between use for inside corners and outside corners.
